(19) United States
(12) Patent Application Publication
(10) Pub. No.: US 2010/0157300 A1
(43) Pub. Date: Jun. 24, 2010

(54) LIQUID SAMPLE ANALYSIS CHIP READING SYSTEM, AND ANALYSIS METHOD AND UBIQUITOUS READING SYSTEM USING THE SAME

(75) Inventors: Dae-Sik Lee, Daejeon (KR); Yo-Han Choi, Daejeon (KR); Hyun-Woo Song, Daejeon (KR); Moon-Youn Jung, Daejeon (KR); Seon-Hee Park, Daejeon (KR); Gun-Yong Sung, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/503,755

(22) Filed: Jul. 15, 2009

(30) Foreign Application Priority Data
Dec. 22, 2008 (KR) 10-2008-0131644

(51) Int. Cl. G01J 3/46

(52) U.S. Cl. 356/402

(57) ABSTRACT

Provided is a liquid sample analysis chip reading system. The reading system includes an analysis chip, a light emitting part, a plurality of light wave-guides, and a light receiving part. The analysis chip includes a plurality of detecting parts. The light emitting part includes three light sources emitting light having wavelengths (or colors) different from each other. The plurality of light wave-guides irradiate the light emitted from the light emitting part onto the plurality of corresponding detecting parts, respectively. The light receiving part includes a plurality of light receiving devices for receiving the light having a specific color reflected from each of the plurality of corresponding detecting parts of the analysis chip. The three light sources are discontinuously controlled to emit light onto the plurality of light wave-guides.

### CROSS-REFERENCE TO RELATED APPLICATIONS

This U.S. non-provisional patent application claims priority under 35 U.S.C. §119 of Korean Patent Application No. 10-2008-0131644, filed on Dec. 22, 2008, the entire contents of which are hereby incorporated by reference.

### BACKGROUND OF THE INVENTION

The present invention disclosed herein relates to a bio-microelectromechanical system (bio-MEMS), and more particularly, to a liquid sample analysis chip reading system, and an analysis method and a ubiquitous reading system using the same.

In general, individually various test items are used in a strip chip for analyzing urination. The test items include occult blood, bilirubin, urobilinogen, ketone body, protein, nitrite, glucose, pH, specific gravity, white blood corpuscles, or vitamin-C. A urine test by a dipstick using the strip chip is a semiquantitative test for a primary screening test of various diseases of a human body. Thus, the urine test by the dipstick using the strip chip is known as a method that can previously detect whether the human body is normal or abnormal.

Since sampling of urine is easy, a subject has a low pressure with respect to the test, and the test results are directly determined due to an immediate response, availability of the strip chip is much higher. The strip chip displays the test results such that a user visually confirms whether the test results with respect to the corresponding test items are normal. The user can simply use the strip chip without requiring an auxiliary device.

However, since such a strip chip uses a corresponding test portion with respect to each of the test items appended to a plastic film, color patterns resulting from the test results may have invisible detection ranges. In addition, since the test results may be differently distinguished according to individual sensibility and emotion, accuracy may be low. Also, since the strip chip does not store the test results that may be utilized later, it is difficult to utilize measurement data.

In case of a reader being sold in the market, an expensive and bulky reader that is available in the hospital is being used. On the other hand, a portable urine test reader in which general public is easily available in a home was not reported yet.

For another example, there is a reader capable of reading optical pattern results analyzed using a strip chip in which light such as a visible ray may be transmitted through a thickness of the strip chip. The reader may accurately testable than the existing reader in which the patterns are read with the naked eye. However, when feeble patterns due to refraction of the light are read, there is a possibility that accuracy is low. Also, the reader is used for a reading purpose commenting with a simple YES/NO, and an auxiliary device for storing or transmitting data is required.

### SUMMARY OF THE INVENTION

The present invention provides a liquid sample analysis chip reading system that can effectively obtain a further accurate optical detection result from a liquid sample analysis chip using a three color light-emitting source and light wave-guide in a bio-microelectromechanical device field.

The present invention also provides an analysis method that can effectively obtain a further accurate optical detection result from a liquid sample analysis chip using a three color light-emitting source and light wave-guides in a bio-microelectromechanical device field.

The present invention also provides a ubiquitous liquid sample analysis chip reading system that can transmit an optical detection result further effectively and accurately obtained from a liquid sample analysis chip using a three color light-emitting source and light wave-guides to a remote place and receive information thereof in a bio-microelectromechanical device field.

Embodiments of the present invention provide liquid sample analysis chip reading systems include an analysis chip comprising a plurality of detecting parts; a light emitting part comprising three light sources emitting light having wavelengths (or colors) different from each other; a plurality of light wave-guides for irradiating the light emitted from the light emitting part onto the plurality of corresponding detecting parts of the analysis chip, respectively; and a light receiving part comprising a plurality of light receiving devices for receiving the light having a specific color reflected from each of the plurality of corresponding detecting parts of the analysis chip, wherein the three light sources of the light emitting part are discontinuously controlled to emit light onto the plurality of light wave-guides.

In some embodiments, the light receiving part may further include a reference light receiving device for detecting a signal intensity change of the light emitted from the light emitting part. The liquid sample analysis chip reading systems may further include an additional light wave-guide for directly irradiating the light emitted from the light emitting part onto the reference light receiving device. The plurality of light receiving devices and the reference light receiving device may include at least one of a photo diode, a photo triode, a CMOS image sensor, and a charge coupled device (CCD).

In other embodiments, the analysis chip may include a bio-chip or a strip chip.

In still other embodiments, the analysis chip may include the bio-chip, and the bio-chip may further include a fluid control module for moving, stopping, and mixing fluid. The fluid control module may include: a storage part for storing the fluid; a pump for transferring the fluid; a valve for controlling the transference of the fluid; and a fluid control part for adjusting a flow of the fluid.

In even other embodiments, each of the three light sources may include a light emitting device or a laser diode. The three light sources may emit red light, green light, and blue light, respectively.

In yet other embodiments, the liquid sample analysis chip reading systems may include a plurality of light shielding parts respectively disposed between the plurality of light wave-guides and the plurality of corresponding light receiving devices.

In other embodiments of the present invention, analysis methods using a liquid sample analysis chip reading system include applying at least one of samples to the plurality of detecting parts of an analysis chip; discontinuously controlling three light sources emitting light having wavelengths (or colors) different from each other to irradiate light onto the plurality of detecting parts; and receiving light having a specific color reflected from each of the plurality of detecting parts of the analysis chip into a plurality of corresponding light receiving devices, respectively.

In some embodiments, the analysis methods may further include directly receiving the light emitted from the three light sources to correct a signal intensity change value of the light.

In other embodiments, the analysis methods may further include converting the light having the specific color received from each of the plurality of light receiving devices into an electrical signal.

In still other embodiments, depths of the colors of the plurality of detecting parts of the analysis chip may be determined using color values.

In still other embodiments of the present invention, ubiquitous liquid sample analysis chip reading systems include an analysis chip comprising a plurality of detecting parts to which at least one of samples is applied; a light emitting part comprising three light sources emitting light having wavelengths (or colors) different from each other; a plurality of light wave-guides for irradiating the light emitted from the light emitting part onto the plurality of corresponding detecting parts of the analysis chip, respectively; a light receiving part comprising a plurality of light receiving devices for receiving the light having a specific color reflected from each of the plurality of corresponding detecting parts of the analysis chip; a control part for analyzing an electrical signal converted by the light receiving part; a display part for displaying an analysis result analyzed by the control part; and a communication part for transmitting the analysis result to a remote terminal, wherein the three light sources of the light emitting part are discontinuously controlled by the control part to emit light onto the plurality of light wave-guides.

In some embodiments, the light receiving part may further include a reference light receiving device for detecting a signal intensity change of the light emitted from the light emitting part. The ubiquitous liquid sample analysis chip reading systems may further include an additional light wave-guide for directly irradiating the light emitted from the light emitting part onto the reference light receiving device. The plurality of light receiving devices and the reference light receiving device may include at least one of a photo diode, a photo triode, a CMOS image sensor, and a CCD.

In other embodiments, the analysis chip may include a bio-chip or a strip chip. The analysis chip may include the bio-chip, and the bio-chip may further include a fluid control module for moving, stopping, and mixing fluid. The fluid control module may include: a storage part for storing the fluid; a pump for transferring the fluid; a valve for controlling the transference of the fluid; and a fluid control part for adjusting a flow of the fluid.

In still other embodiments, each of the three light sources may include a light emitting device or a laser diode. The three light sources may emit red light, green light, and blue light, respectively.

In even other embodiments, the ubiquitous liquid sample analysis chip reading systems may further include a plurality of light shielding parts respectively disposed between the plurality of light wave-guides and the plurality of corresponding light receiving devices.

In yet other embodiments, the control part may include a micro control unit (MCU).

In further embodiments, the communication part may include a radio frequency identification (RFID) tag or a communication module. The RFID tag may include a RFID chip for recording the analysis result and a RFID antenna for transmitting the analysis result to an external RFID reader. The communication module may include a wireless recognition chip for recording the analysis result and a mobile communication modem for transmitting the analysis result to the remote terminal.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram of a ubiquitous liquid sample analysis chip reading system according to an embodiment of the present invention;

FIGS. 2A and 2B are a functional block diagram and a schematic view for explaining a ubiquitous liquid sample analysis chip reading system according to an embodiment of the present invention, respectively;

FIG. 3 is an exploded cross-sectional view of a portion “A” of FIG, 2A in order to explain a relationship between a light emitting part, an analysis chip, and a light receiving part of a ubiquitous liquid sample analysis chip reading system according to an embodiment of the present invention; and

FIG. 4 is a graph for explaining an analysis method of a ubiquitous liquid sample analysis chip reading system according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Since preferred embodiments are provided below, the order of the reference numerals given in the description is not limited thereto. In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present.

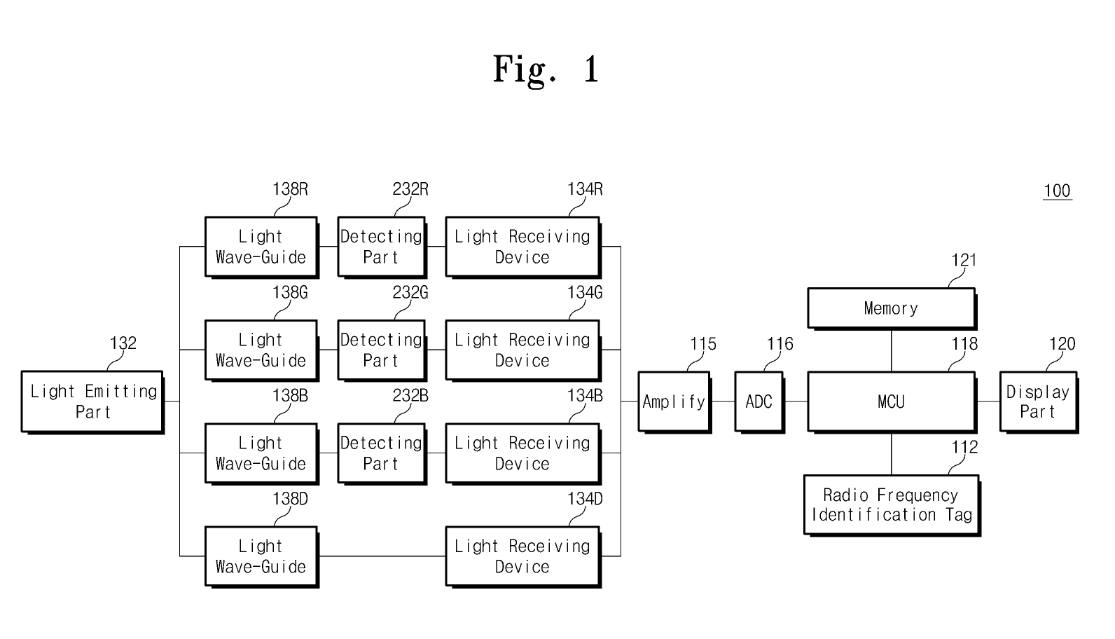

FIG. 1 is a block diagram of a ubiquitous liquid sample analysis chip reading system according to an embodiment of the present invention.

Referring to FIG. 1, a ubiquitous liquid sample analysis chip reading system 100 may include a light emitting part 132, four light wave-guides 138R, 138G, 138B, and 138D, three detecting parts 232R, 232G, and 232B, four light receiving devices 134R, 134G, 134B, and 134D, an amplifier 115, an analog/digital converter (ADC) 116, a micro control unit (MCU) 118, a memory 121, a radio frequency identification tag (RFID tag) 112, and a display part 120.

FIG. 1 only shows the four light wave-guides 138R, 138G, 138B, and 138D, the three detecting parts 232R, 232G, and 232B, and the four light receiving devices 134R, 134G, 134B, and 134D, but the ubiquitous liquid sample analysis chip reading system according to an embodiment of the present invention may further include more light wave-guides, more detecting parts, and more light receiving devices.

The light emitting part 132 may include three light sources that are emit light having wavelengths (or colors) different from each other.

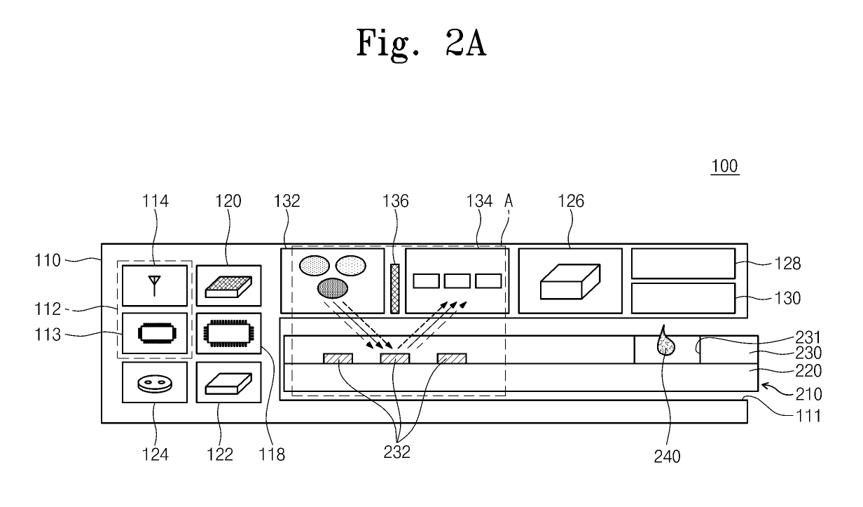

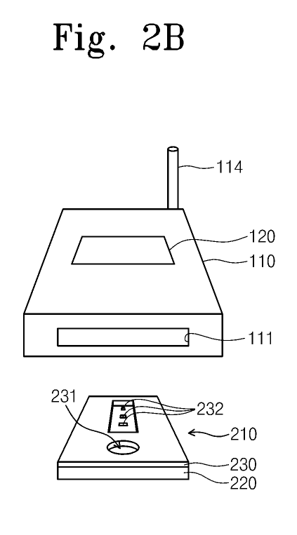

The four light wave-guides 138R, 138G, 138B, and 138D may irradiate light emitted from the light emitting part 132 onto the three detecting parts 232R, 232G, and 232B of an analysis chip (See reference numeral 210 of FIG. 2A) and the reference light receiving device 134D, respectively.

The three light receiving devices 134R, 134G, and 134B may receive light having specific colors reflected by three detecting parts 232R, 232G, and 232B to convert the received light into electrical signals, respectively.

The reference light receiving device 134D may directly receive the light emitted from the light emitting part 132 to detect a signal intensity change of the light.

The amplifier 115 may amplify the electrical signals detected by three light receiving devices 134R, 134G, and 134B and the reference light receiving device 134D.

The ADC 116 may convert the signals amplified by the amplifier 115 into digital signals.

The MCU 118 may control the three light sources of the light emitting part 132 to discontinuously emit the light of the respective colors in a switching form, analyze the digital signals inputted by the ADC 116, and deduce a final analysis result of a sample by correcting analyzed data using values of a color coordinate system and the reference light receiving device 134D.

The memory 121 may store the result analyzed by the MCU 118.

The RFID tag 112 may transmit the result analyzed by the MCU 118 to an external RFID reader (not shown).

The display part 120 may display the result analyzed by the MCU 118 on an external screen.

A configuration and an operation method of the ubiquitous liquid sample analysis chip reading system according to the present invention will be additionally described in detail with reference to FIGS. 2A and 2B.

FIGS. 2A and 2B are a functional block diagram and a schematic view for explaining a ubiquitous liquid sample analysis chip reading system according to an embodiment of the present invention, respectively.

Referring to FIGS. 2A and 2B, the ubiquitous liquid sample analysis chip reading system 100 may include a reader 110 and the analysis chip 210.

The reader 110 may include an analysis chip insertion hole 111, the RFID tag 112, the MCU 118, the display part 120, a mechanical part 122, a battery part 124, a fluid control modules 126, 128, and 130, and a light measurement parts 132 and 134.

The RFID tag 112 may include a RFID chip 113 and a RFID antenna 114. The RFID tag 112 may store an analysis result to be measured with respect to a fluid sample 240 in the RFID chip 113 and transmit the stored analysis result to the external RFID reader (not shown) through the RFID antenna 114. That is, the RFID tag 112 receives the analysis result from the MCU 118 to record the received analysis result in the RFID chip 113. When a user intends to transmit the analysis result to a remote place, the RFID tag 112 receives the analysis result from the RFID chip 113 to transmit the analysis result to a remote terminal using a wire or wireless terminal installed in the RFID reader.

A communication part including a wireless recognition chip and a mobile communication modem may be replaced with the RFID tag 112. The wireless recognition chip may record the result analyzed by the MCU 118. The mobile communication modem may wirelessly communicate with the remote terminal through a mobile communication network. The communication part receives the analysis result having a specific data format to transmit the analysis result to a remote terminal selected by the user through wireless data communication.

The MCU 118 may control an operation of the reader 110 including the light measurement parts 132 and 134. The MCU 118 may amplifies the electrical signal measured by the light measurement parts 132 and 134, convert the measured electrical signal into the digital signal, and analyze the converted digital signal. Thus, the MCU 118 may be called a control part. The display part 120 may display the result analyzed by the MCU 118. The memory 121 may store the result analyzed by the MCU 118. The memory 121 may be incorporated with the RFID chip 113 of the RFID tag 112.

The mechanical part 122 may couple the analysis chip 210 inserted into the analysis chip insertion hole 111 to the reader 110. In the coupling between the analysis chip 210 and the reader 110, the analysis chip 210 may be inserted using a lever including an elastic material (e.g., a spring) provided in the reader 110, and when the analysis chip 210 reaches a predetermined position, the analysis chip 210 may be fixed to a recess defined in the lever. As a result, the analysis chip 210 may be fixed to the analysis chip insertion hole 111. At this time, a structure for fixing the analysis chip 210 which is coupled to the spring or a guiding groove must be installed in the reader 110 disposed over the analysis chip 210. The structure for fixing the analysis chip 210 can analyze the analysis chip 210 regardless of an impact or shaking applied from the outside during the analysis of the analysis chip 210.

Also, in order to easily detach the analysis chip 210, a detaching lever coupled to a tilting spring may be installed in the reader 110. In addition, an upper case and a lower case of the reader 110 may be forcedly coupled to each other using an additional structure having a clip shape, or the upper case and the lower case may be coupled to each other in a manner in which one of the upper case and the lower case of the reader 110 has an embossed groove, and the other has an depressed groove to fit the embossed groove into the depressed groove. In case where the upper case is coupled to the lower case, a polymer having elasticity may be additionally provided on a contact surface between the upper case and the lower case in order to prevent a fine gap from being generated.

The battery part 124 supplies a power source necessary for operating the reader 110 to the reader 110.

The fluid control modules 126, 128, and 130 may include a fluid storage part 126, a fluid control pump 128, and a fluid control valve 130. The fluid control modules 126, 128, and 130 may be modules for efficiently analyzing the fluid sample 240 in the analysis chip 210. The fluid storage part 126 stores various solutions (body fluids, blood, buffer solution, cleaning solution, etc) including the fluid sample 240 provided into the analysis chip 210. The fluid control pump 128 may extract the solutions within the fluid storage part 126. The fluid control valve 130 may inject the solutions extracted from the fluid storage part 126 into the analysis chip 210. In order to move, stop, and mix the fluids in the analysis chip 210, various existing driving devices such as a constant voltage motor, a piezoelectric pump, an oil pressure or an air pressure, and an ultrasonic wave may be used.

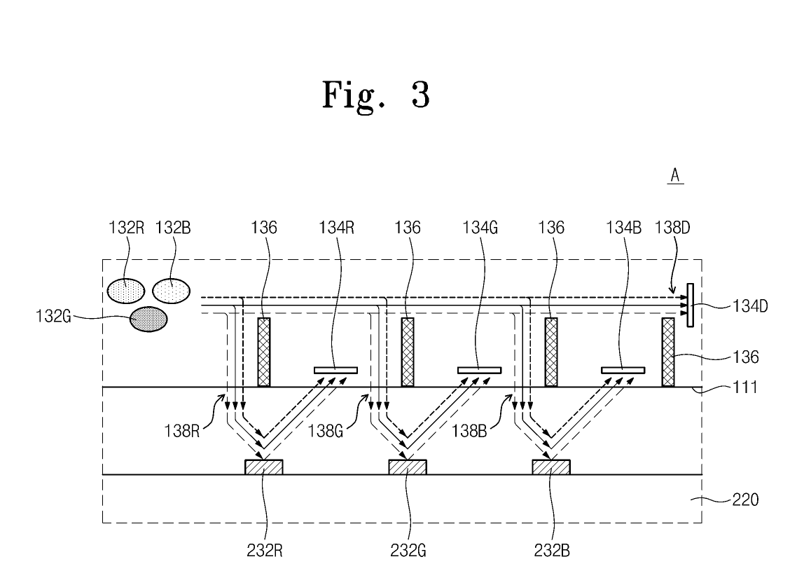

The light measurement parts 132 and 134 may include a light emitting part 132 and a light receiving part 134. The light emitting part 132 may include three light sources for irradiating light having respective colors (arrows) onto three detecting parts 232 of the analysis chip 210. The light receiving part 134 may include the three light receiving devices for detecting light having the specific colors in which the light irradiated from the light emitting part 132 is respectively reflected by the three detecting parts 232 of the analysis chip 210. In order to prevent the light irradiated from the light emitting part 132 from being directly transmitted to the three light receiving devices, a light shielding part 136 may be provided between the light emitting part 132 and the light receiving part 134. The light shielding part 136 will be additionally described in detail with reference to FIG. 3.

FIG. 2A only shows the three detecting parts 232, the three light receiving devices, and the one light shielding part 136, but the ubiquitous liquid sample analysis chip reading system according to an embodiment of the present invention may further include more detecting parts, more light receiving devices, and more light shielding parts.

The analysis chip 210 may include a bio-chip or a strip chip. In case where the analysis chip 210 is the bio-chip, the analysis chip 210 may include a lower substrate 220 and an upper substrate 230. A fluid sample injection hole 231 for receiving the solution from the fluid control modules 126, 128, and 130 of the reader 110 may be defined in the upper substrate 230 of the analysis chip 210. A detection electrode part 232 in which the fluid sample 240 to be measured can biochemically react may provided in the lower substrate 220 of the analysis chip 210. The three detecting parts 232 of the analysis chip 210 may include a metal material that can reflect light.

In case where the analysis chip 210 is the bio-chip, the previously described fluid control modules 126, 128, and 130 may built in the analysis chip 210. As a result, the reader 110 may not include the fluid control modules 126, 128, and 130.

An operation method of the ubiquitous liquid sample analysis chip reading system 100 will be described.

When the analysis chip 210 is inserted into the analysis chip insertion hole 111 of the reader 110, a switch turns on to apply a signal notifying a state in which the analysis chip 210 was inserted into the reader 110 to the MCU 118. The MCU 118 applies a power source for sequentially driving the three light sources in a discontinuous switching form to the light emitting part 132. The light having the specific colors are discontinuously emitted from the three light sources, and the emitted light having the specific colors is reflected by the three detecting parts 232 to detect each of the specific colors by the three light receiving devices. The light receiving part 134 converts signals of light having the specific colors respectively detected by the three light receiving devices into electrical signals. The electrical signals converted by the light receiving part 134 are transmitted to the MCU 118. The MCU 118 amplifies the electrical signals transmitted from the light receiving part 134, converts the amplified electrical signals into digital signals, and analyzes the digital signals. The MCU 118 displays the analyzed results on a screen through the display part 120. Also, the MCU 118 records the analyzed results in RFID chip 114 or transmits the analyzed results to remote terminal through the mobile communication modem.

FIG. 3 is an exploded cross-sectional view of a portion “A” of FIG, 2A in order to explain a relationship between a light emitting part, an analysis chip, and a light receiving part of a ubiquitous liquid sample analysis chip reading system according to an embodiment of the present invention.

Referring to FIG. 3, the light having the specific colors may be discontinuously emitted from the three light sources 132R, 123G, and 132B, and the emitted light may be reflected by the three detecting parts 232R, 232G, and 232B of the analysis chip (See reference numeral 210 of FIG. 2A), respectively. The reflected light may be detected by the three light receiving devices 134R, 134G, and 134B in each of the specific colors. In addition, the light emitted from the three light sources 132R, 132G, and 132B may be directly irradiated onto the reference light receiving device 134D. The reference light receiving device 134D may detect the signal intensity change of the light emitted from the three light sources 132R, 132G, and 132B to provide correction values with respect to detected values of the three light receiving devices 134R, 134G, and 134B to the MCU (See reference numeral 118 of FIG. 2A).

Each of the three light sources 132R, 132G, and 132B may include a light emitting diode (LED) or a laser diode (LD). As illustrated in FIG. 3, the three light sources 132R, 132G, and 132B may include a red light source, a green light source, and a blue light source, respectively. As a result, the three light sources 132R, 132G, and 132B may emit red light, green light, and blue light, respectively. The light irradiated from the three light sources 132R, 132G, and 132B may have a wavelength ranging from about 400 nm to about 2,000 nm and a frequency ranging from about 1 kHz to about 1 MHz.

The three light receiving devices 134R, 134G, and 134B may include at least one of a photo diode, a photo triode, and a charge coupled device (CCD). Thus, the three light receiving devices 134R, 134G, and 134B may be implemented in a silicon array form. Therefore, detection sensitivity of the reader (See reference numeral 110 of FIG. 2A) may be secured, and also, the three light receiving device 134R, 134G, and 134B may be incorporated with the reader.

The three light wave-guides 138R, 138G, and 138B for irradiating light onto the three light receiving devices 134R, 134G, and 134B and light shielding parts 136 respectively disposed between the light receiving devices 134R, 134G, and 134B may be provided. The light shielding parts 136 may prevent the light irradiated through the three light wave-guides 138R, 138G, and 138B from being directly transmitted to the corresponding light receiving devices 134R, 134G, and 134B. Thus, accuracy with respect to light discrimination may be improved.

Since the ubiquitous liquid sample analysis chip reading system according to the present invention uses the three light sources 132R, 132G, and 132B, a signal to noise ratio may be significantly reduced as comparison with a case in which a single light source is used. In case of the single light source, accuracy may be reduced near a decision threshold value due to a high signal to noise ratio in a process in which the specific colors are detected through the light receiving part (See reference numeral 134 of FIG. 2A) to analyze the detected colors through the MCU. In case where the specific colors are detected using the three light receiving devices 134R, 134G, and 134B corresponding to each of wavelengths (or colors) of the three light sources 132R, 132G, and 132B, since the wavelength and brightness may be analyzed at the same time, analysis accuracy may be improved, and the analysis results with respect to the analysis chip may be reproducibly achieved. This is done because the three light sources 132R, 132G, and 132B are discontinuously controlled in the switching form.

FIG. 3 only shows the three detecting parts 232R, 232G, and 232B, the four light wave-guides 138R, 138G, 138B, and 138D, the four light receiving devices 138R, 138G, 138B, and 138D, and the four light shielding parts 136, but the ubiquitous liquid sample analysis chip reading system according to an embodiment of the present invention may further include more detecting parts, more light wave-guides, more light receiving devices, and more light shielding parts.

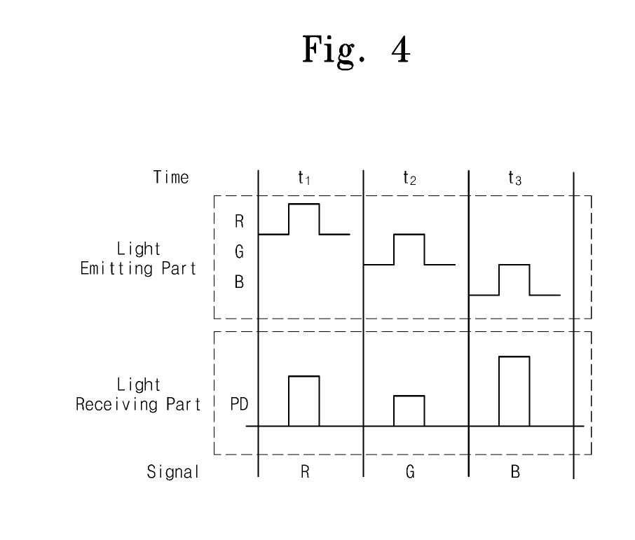

FIG. 4 is a graph for explaining an analysis method of a ubiquitous liquid sample analysis chip reading system according to an embodiment of the present invention.

Referring to FIG. 4, a red light source operates during a first time t1 to store a signal value with respect to red light R in a red light receiving device reacting with the red light R. Thereafter, a green light source operates during a second time t2 to store a signal value with respect to green light G in a green light receiving device reacting with the green light G. Lastly, a blue light source operates during a third time t3 to store a signal value with respect to blue light B in a blue light receiving device reacting with the blue light B. Using the signal values with respect to the red light R, the green light G, and the blue light B stored through this processes, a depth of the sample may be measured by the color values. In addition, using intensity value, it may be determined whether or not the analysis chip exists and whether or not the ubiquitous liquid sample analysis chip reading system is normal.

As described above, since the signals of the three light sources included in one light emitting part are hourly detected, the depth having high reproducibility may be measured using the signals received from the light receiving part. Also, it may be simply and reliably determined whether the analysis chip and the reader system including the analysis chip are normal.

In the liquid sample analysis chip reading system, and the analysis method and the ubiquitous reading system the same according to an embodiment of the present invention, inaccuracy to be generated through a determination with the naked eye or a determination using a transmission property for the disease diagnosis may be improved, and also, the determined result may be transmitted to the terminal of the hospital or an individual's attending physician at all the time and in every place. Thus, a semi-quantitative analysis of the detected optical data may be quickly and accurately performed, and the user may simply understand the analysis result.

Also, in the liquid sample analysis chip reading system, and the analysis method and the ubiquitous reading system the same according to an embodiment of the present invention, since the reading system is associated with the wireless communication module to transmit individual medical information to the terminal of a specific hospital or the individual's attending physician, it's easily to take care of your health in ubiquitous society environment that will come in the near future. Target biomaterials of the analysis chip may include bio markers related to cancers, hormones related to pregnancy or ovulation, body fluids such as blood revealing an individual health state, germ virus such as bird flu, and toxic drugs.

As described above, according to the present invention, provided is a liquid sample analysis chip reading system in which the color and intensity of light reflected from the detecting parts can be analyzed using the three light sources that can emit light having the specific color, respectively, and the light wave-guides to effectively obtain the further accurate optical detection result.

Also, according to the present invention, provided is an analysis method of the liquid sample analysis chip reading system in which the color and intensity of light reflected from the detecting parts can be analyzed using the three light sources that can emit light having the specific color, respectively, and the light wave-guides to effectively obtain the further accurate optical detection result.

In addition, according to the present invention, provided is a ubiquitous liquid sample analysis chip reading system in which the color and intensity of light reflected from the detecting parts can be analyzed using the three light sources that can emit light having the specific color, respectively, and the light wave-guides to transmit the optically detected result further accurately obtained from the liquid sample analysis chip reading system to the remote place or receive the information thereof

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A liquid sample analysis chip reading system comprising:
an analysis chip comprising a detecting part;
a light emitting part comprising three light sources emitting light having wavelengths different from each other;
a light wave-guide for irradiating the light emitted from the light emitting part onto the corresponding detecting part; and
a light receiving part comprising a receiving device for receiving the light having a specific color reflected from the corresponding detecting part of the analysis chip.

2. The liquid sample analysis chip reading system of claim 1, wherein the three light sources of the light emitting part are discontinuously controlled to emit light onto the light wave-guide.

3. The liquid sample analysis chip reading system of claim 1, wherein the light receiving part further comprises a reference light receiving device for detecting a signal intensity change of the light emitted from the light emitting part.

4. The liquid sample analysis chip reading system of claim 1, further comprising an additional light wave-guide for directly irradiating the light emitted from the light emitting part onto the reference light receiving device.

5. The liquid sample analysis chip reading system of claim 1, wherein the three light sources emit red light, green light, and blue light, respectively.

6. The liquid sample analysis chip reading system of claim 1, further comprising a light shielding part disposed between the light wave-guide and the corresponding light receiving device.

7. An analysis method using a liquid sample analysis chip reading system comprising:
applying a sample to a detecting part of an analysis chip;
discontinuously controlling three light sources emitting light having wavelengths different from each other to irradiate light onto the corresponding detecting part; and
receiving light having a specific color reflected from the corresponding detecting part of the analysis chip into a light receiving device.

8. The analysis method of claim 7, further comprising directly receiving the light emitted from the three light sources to correct a signal intensity change value of the light.

9. The analysis method of claim 7, further comprising converting the light having the specific color received from the light receiving device into an electrical signal.

10. The analysis method of claim 7, wherein a depth of color of the wavelength of the detecting part of the analysis chip is determined using color values.

11. A ubiquitous liquid sample analysis chip reading system, comprising:
an analysis chip comprising a detecting part to which a sample is applied;
a light emitting part comprising three light sources emitting light having wavelengths different from each other;
a light wave-guide for irradiating the light emitted from the light emitting part onto the corresponding detecting part of the analysis chip;
a light receiving part comprising a light receiving device for receiving the light having a specific color reflected from the corresponding detecting part of the analysis chip;
a control part for analyzing an electrical signal converted by the light receiving part;
a display part for displaying an analysis result analyzed by the control part;
and
a communication part for transmitting the analysis result to a remote terminal.

12. The ubiquitous liquid sample analysis chip reading system of claim 11, wherein the three light sources of the light emitting part are discontinuously controlled by the control part to emit light onto the light wave-guide.

13. The ubiquitous liquid sample analysis chip reading system of claim 11, wherein the light receiving part further comprises a reference light receiving device for detecting a signal intensity change of the light emitted from the light emitting part.

14. The ubiquitous liquid sample analysis chip reading system of claim 13, further comprising an additional light wave-guide for directly irradiating the light emitted from the light emitting part onto the reference light receiving device.

15. The ubiquitous liquid sample analysis chip reading system of claim 11, wherein the three light sources emit red light, green light, and blue light, respectively.

16. The ubiquitous liquid sample analysis chip reading system of claim 11, further comprising a light shielding part disposed between the light wave-guide and the corresponding light receiving device.

17. The ubiquitous liquid sample analysis chip reading system of claim 11, wherein the control part comprises a micro control unit (MCU).

18. The ubiquitous liquid sample analysis chip reading system of claim 11, wherein the communication part comprises a radio frequency identification (RFID) tag or a communication module.

19. The ubiquitous liquid sample analysis chip reading system of claim 18, wherein the RFID tag comprises a RFID chip for recording the analysis result and a RFID antenna for transmitting the analysis result to an external RFID reader.

20. The ubiquitous liquid sample analysis chip reading system of claim 18, wherein the communication module comprises a wireless recognition chip for recording the analysis result and a mobile communication modem for transmitting the analysis result to the remote terminal.
